(19) United States
(12) Patent Application Publication
(10) Pub. No.: US 2004/0040319 A1
(43) Pub. Date: Mar. 4, 2004

(54) Cooling fan control device

(76) Inventor: Jong-Wuk Lee, Gyeonggi-do (KR)

Correspondence Address: Pennie & Edmonds, LLP, 3300 Hillview Avenue, Palo Alto, CA, 94304, US

(21) Appl. No.: 10/465,903

(22) Filed: Jun. 18, 2003

(30) Foreign Application Priority Data
Aug. 27, 2002 (KR) 2002-50794

(51) Int. Cl. B60H 1/32; F25B 39/04

(52) U.S. Cl. 62/133; 62/184

(57) ABSTRACT

The present invention provides a cooling fan control device configured to use a single cooling fan instead of a double cooling fan for cooling an air conditioner and a radiator. The cooling fan control device comprises a vehicle operation state detecting unit; an electronic control unit to output a cooling fan control signal according to a preset program; a first power supply unit for supplying a high fan speed driving power to a cooling fan motor; and a second power supply unit for supplying a low fan speed driving power to the cooling fan motor according to the cooling fan control signal output from the electronic control unit.

### FIELD OF THE INVENTION

The present invention relates to a cooling fan control device, and more particularly, to a cooling fan control device configured to use a single fan instead of a double cooling fan for cooling an air conditioner and a radiator.

### BACKGROUND OF THE INVENTION

Generally, a cooling fan attached to the rear side of a radiator provides ventilation and a cooling effect of the radiator, and prevents overheating of the exhaust manifold while the vehicle is operating at high speed. Today's conventional engine cooling fan is primarily electric and automatically adjusts the rotation of the fan to reduce power consumption, engine overheating and noise.

The cooling fan is adjusted according to the cooling water temperature and the vehicle speed. The control circuit of a conventional double cooling fan includes an air conditioner condenser cooling fan (e.g., 160 W), and a radiator cooling fan (e.g., 160 W). An electronic control unit (ECU) controls in two steps the revolution of the radiator cooling fan and the condenser cooling fan in relation to the cooling water temperature of the engine or refrigerant pressure of the air conditioner, thereby decreasing the noise. The output terminal of the Electronic Control Unit (ECU) is typically grounded to operate the cooling fan according to the cooling fan logic. However, in conventional ECU logic, if both a high terminal (H) and a low terminal (L) are turned OFF, the radiator fan and the air conditioner condenser fan do not operate. If the high terminal (H) is turned OFF and the low terminal (L) is turned ON, the coil of the radiator fan relay is magnetized to allow the switch of the relay to be turned ON, applying power to the radiator fan. Under these conditions, the second condenser relay is turned OFF to apply power to the condenser fan and to prompt the radiator fan and the condenser fan to form a serial circuit, thereby allowing the radiator fan and the condenser fan to rotate at a low speed.

Furthermore, if the low terminal (L) is turned ON (the low terminal (L) is grounded) and the high terminal (H) is turned ON (the high terminal (H) is grounded), the coil of the third relay is magnetized to allow a switch of a third relay to be turned ON and grounded. Thus, as the first relay is turned ON, the radiator fan is driven, and at the same time, the second relay is turned ON to drive the condenser fan. Each circuit operates in parallel to drive the fans at a high speed.

However, there are drawbacks with the conventional double cooling fan control device thus described. For example, there are many parts associated with the device and its circuits are complicated, thereby having a high manufacturing cost.

### SUMMARY OF THE INVENTION

The present invention provides a cooling fan control device for cooling a radiator and air conditioner condenser of a vehicle using a single fan with a cooling fan control circuit having a high preset nominal output. In accordance with one embodiment of the present invention, the cooling fan control device comprises vehicle operation state detecting means for detecting the cooling water temperature, vehicle speed, air conditioner switch state and refrigerant pressure as they vary in response to vehicle operation state changes. An electronic control unit receives data detected by the detecting means to output a cooling fan control signal according to a preset program. A first power supply unit supplies a high fan speed driving power to a cooling fan motor according to the cooling fan control signal output from the electronic control unit. A second power supply unit supplies a low fan speed driving power to the cooling fan motor according to the cooling fan control signal output from the electronic control unit.

The first power supply unit preferably comprises a power source, a rated voltage fuse, and a relay for switchingly operating in response to the control of the electronic control unit to selectively provide power via the fuse to the cooling fan motor. The second power supply unit preferably comprises a power source, a rated voltage fuse, a relay for switchingly operating in response to the control of the electronic control unit to selectively provide power via the fuse to the cooling fan motor, and a register for dropping the voltage of the power supplied via the relay to provide same to the cooling fan motor.

In an alternative embodiment the present invention includes an electronic control unit and two power supply units. The electronic control unit is configured to receive vehicle state information and to generate a cooling fan signal based on the state information. The first power supply unit communicates with the electronic control unit and is configured to supply high speed driving power to a cooling fan in accordance with the control signal. The second power supply unit also communicates with the electronic control unit and is configured to supply low speed driving power to the cooling fan in accordance with the control signal. Preferably, the vehicle state information comprises cooling water temperature, vehicle speed, air conditioner switch state and air conditioner refrigerant pressure.

In a further preferred embodiment, the electronic control unit generates the control signal in accordance with a control logic that comprises steps of comparing the actual vehicle speed with at least one preset speed and the actual cooling water temperature with at least one preset temperature. The control logic may further comprise determining whether the air conditioner switch is on or off and executing a first or a second set of speed and temperature comparisons depending on the state of the switch.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic circuit drawing of a cooling fan control device according to an embodiment of the present invention;

FIG. 2 is a schematic circuit diagram of an embodiment of the present invention during a high speed driving control of a cooling fan;

FIG. 3 is a schematic circuit diagram of an embodiment of the present invention during a low speed driving control of a cooling fan; and

FIGS. 4A and 4B illustrate an operation process drawing of cooling fan control method according to an embodiment of the present invention.

### DETAILED DESCRIPTION OF THE INVENTION

As this invention may be embodied in several forms without departing from the spirit or essential characteristics thereof, the present embodiment is therefore illustrative and not restrictive. Throughout the drawings, like reference numerals are used for designation of like or equivalent parts or portions for simplicity of illustration and explanation, so that redundant references will be omitted.

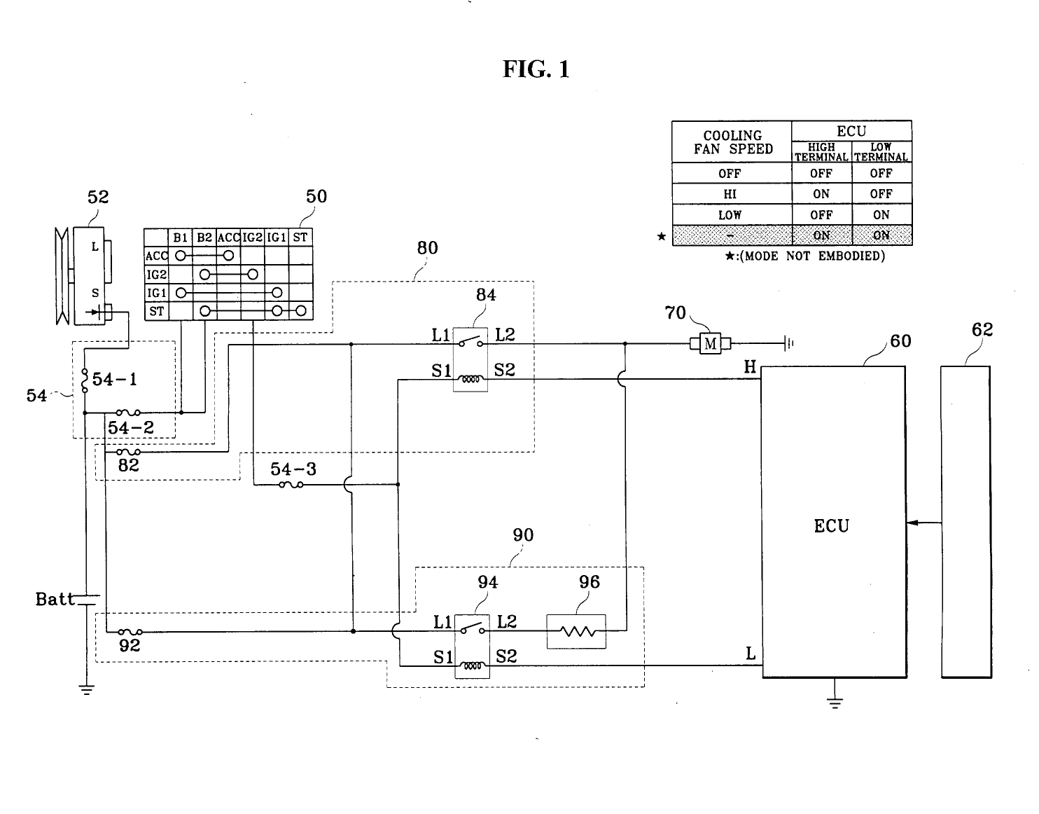

As shown in FIG. 1, the cooling fan control device includes various components as described below. A battery supplies power to a vehicle. An ignition switch 50 supplies power to the vehicle's electrical devices in response to the driver's manipulation of an ignition key. An alternating current (AC) generator 52 supplies power after the vehicle is started. A fuse unit 54 comprises a first fuse 54-1 and a second fuse 54-2. One end of fuse 54-1 is connected to the AC generator 52 and the other end is connected to the positive pole (+) of the battery. First fuse 54-1 has a first preset rated capacity (e.g., 100A) in order to block an over-voltage supplied from the AC generator 52. A second fuse 54-2 has a first preset rated capacity (e.g., 100A). One end of second fuse 54-2 is connected to the ignition switch 50 and the other end is connected to the first fuse 54-1 and the positive pole (+), in order to block the over-voltage supplied from the AC generator 52. A third fuse 54-3 is connected between ignition switch 50 and power supply units 80 and 90 as described below.

An Electronic Control Unit (60, ECU) is initialized when power is supplied and receives, from vehicle operation state detecting means, information regarding the cooling water temperature, vehicle speed, air conditioner switch state, refrigerant pressure and the like, which vary in response to changes of the vehicle operation state. Based on these inputs, ECU 60 outputs a cooling fan control signal according to a preset program as described herein below. A cooling fan 70 is driven in high speed or low speed in response to the control signal output from the ECU 60. A first power supply unit 80 supplies high speed driving power to the cooling fan 70 according to the control signal from the ECU 60. A second power supply unit 90 supplies a low speed driving power to the cooling fan 70 according to the control signal from the ECU 60.

ECU 60 may comprise a processor memory and other associated hardware and software as may be selected by a person of ordinary skill in the art to execute the control method as described herein.

The first power supply unit 80 includes a fourth fuse 82 coupled at one end thereof to the first fuse unit 54 with a preset rated voltage for preventing over-voltage. A relay 84 is provided wherein an L1 terminal of the switch is connected to the other end of the fourth fuse 82 and an L2 terminal is connected to the cooling fan 70. In addition, an S1 terminal of a coil is connected to one end of the third fuse 54-3 and an S2 terminal is connected to a high terminal (H) of the ECU 60. When the coil is excited in response to the grounding of the high terminal (H ) of the ECU 60, the switch is turned on to supply the power for rotating the cooling fan at a high speed.

The second power supply unit 90 includes a fifth fuse 92 having a second preset rated voltage. One end of fifth fuse 92 is connected to one end of the first fuse unit 54 and one end of the fourth fuse 82. The other end of fifth fuse 92 is connected to the other end of the fourth fuse 82 and an L1 terminal of the first relay 84, thereby preventing over-voltage. A second relay 94 is provided with an L1 terminal of the switch connected to the fifth fuse 92, the fourth fuse 82 of the first power supply unit 80 and the L1 terminal of the first relay 84. An S1 terminal of the coil in relay 94 is connected to the third fuse 54-3 and the S1 terminal of the first relay 84 of the first power supply unit 80. An S2 terminal of relay 94 is connected to the low terminal (L) of the ECU 60. When the coil is excited in response to the grounding of the low terminal (L) of the ECU 60, the contact switch is turned on to supply power for rotating the cooling fan through a register 96. One end of register 96 is connected to the L2 terminal of the second relay 94 and the other end is connected to the cooling fan 70 and L2 terminal of the first relay 84, such that voltage supplied from the second relay 94 is lowered to rotate the cooling fan at a low speed.

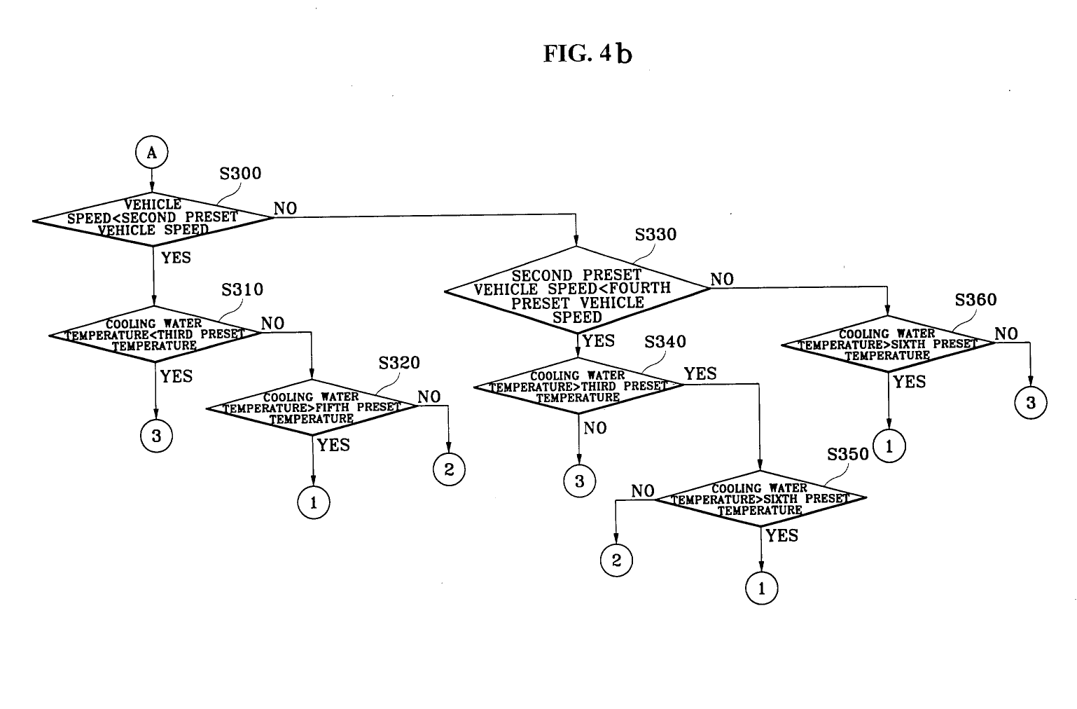

Referring to FIGS. 4a and 4b, a method of the present invention is described in greater detail. When power is supplied to a vehicle, the ECU 60 initializes all factors to be used and a vehicle operating state detecting device 62 detects the cooling water temperature, vehicle speed, air conditioner switch state, refrigerant pressure and the like which vary in response to the operating states of the vehicle. (S100)

The ECU 60 receives the signals related to the cooling water temperature, vehicle speed, air conditioner switch state, refrigerant pressure and the like detected from the vehicle operating state detecting device 62 to determine whether the air conditioner state is turned on by the user. (S110 and S120)

If it is determined at the above steps that the air conditioner is turned on, the ECU 60 determines whether the refrigerant pressure in response to the operation of the air conditioner is above a first preset pressure. (S130). In an exemplary embodiment, the preset pressure may be between about 255-265 psi and more preferably about 259.2 psi.

If it is determined at the above step that the refrigerant pressure in response to the operation of the air conditioner is above the first preset pressure, the ECU 60 grounds the terminal high end (H) for driving the cooling fan at a high speed. (S140) At this time, the ECU 60 drives the cooling fan at a low speed for a preset period of time (e.g., 3 seconds) in order to prevent NVH deterioration, incoming current decrease, dimming of the lamps and the like, and then, when the preset period of time elapses, the ECU 60 drives the cooling fan at a high speed.

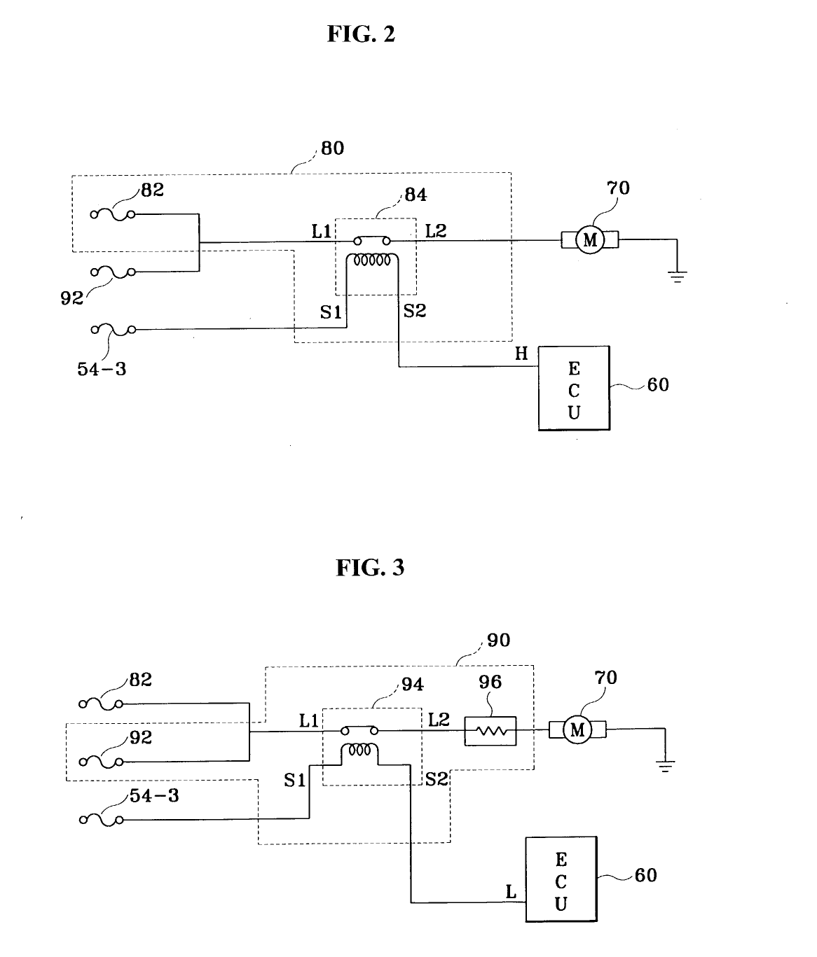

As shown in FIG. 2, in accordance with the grounding of the high (H) terminal, the voltage, applied through the third fuse 54-3 of the fuse unit 54 from an ignition switch 50 illustrated in FIG. 1, flows to the high (H) terminal of the ECU 60 via the coil of the first relay 84 of the first power supply unit 80.

As the coil of the first relay 84 is excited, the switch shown in FIG. 2 is turned on to connect the L1 terminal and L2 terminal, where power applied via the fourth fuse 82 mounted at the first power supply unit 80 and having a first preset rated capacity (e.g., 30 A) and power applied via the fifth fuse 92 mounted at the second power supply unit 90 and having a second preset rated capacity (e.g., 30 A) are connected in parallel to drive the cooling fan motor 70 having a fourth driving capacity (e.g., 380 W) at a high speed. If it is determined at the above step S130 that the refrigerant pressure in relation to the operation of the air conditioner is below the first preset pressure, the ECU 60 advances to determine the speed of a vehicle in motion. (S150). If it is determined at the above step that the vehicle speed is below a first preset speed (e.g., 45 KPH), the ECU 60 determines a changes in the cooling water temperature. If it is determined that the temperature of the cooling water is above a third preset temperature (e.g., 94 degrees Celsius), the ECU 60 performs step S140 where the cooling fan is driven at high speed. (S160). However, if it is determined at the above step that the vehicle speed is below the first preset speed (e.g., 45 KPH) and the temperature of the cooling water is below the third preset temperature (e.g., 94 degrees Celsius), the ECU 60 drives the cooling fan at a low speed. (S170)

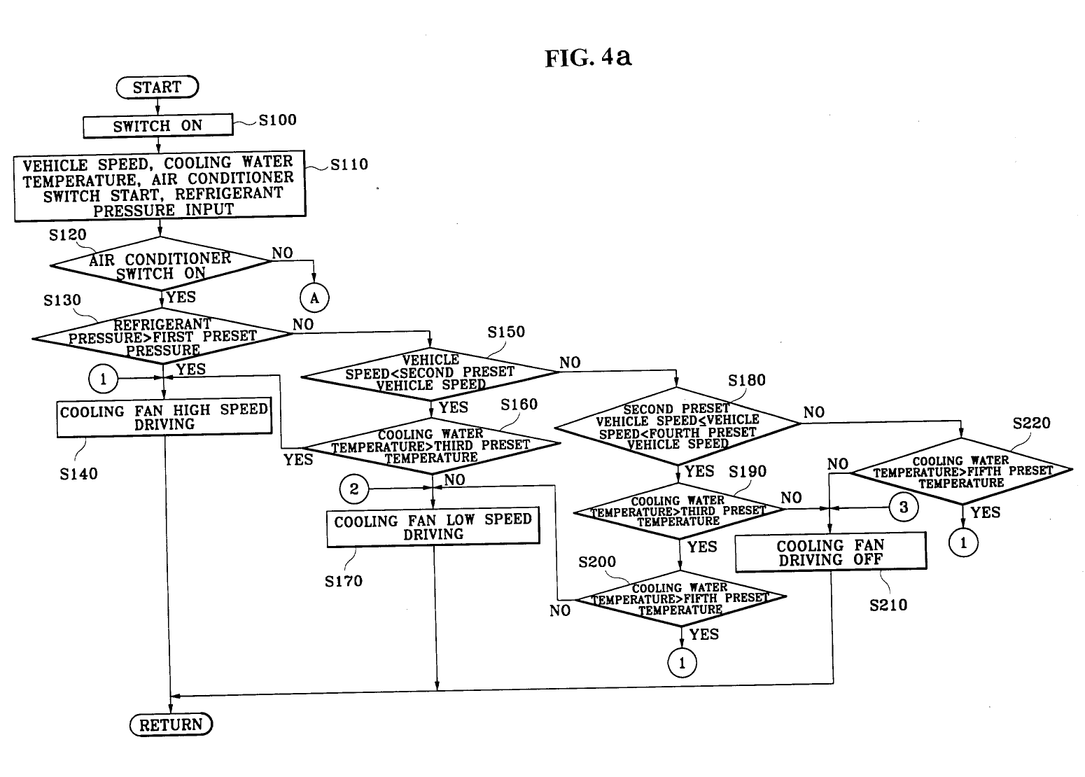

When the ECU 60 drives the cooling fan at a low speed, the low (L) terminal of the ECU 60 as shown in FIG. 1 is grounded. In this state the coil of the second relay 94 of the second power supply unit 90 is excited as illustrated in FIG. 3 to turn on the switch mounted between the L1 terminal and L2 terminal. As a result, when the L1 terminal and L2 terminal are connected, the power applied via the fourth fuse 82 mounted at the first power supply unit 80 and having the first preset rated capacity (e.g., 30 A) and the power applied via the fifth fuse 92 mounted at the second power supply unit 90 and having the second preset rated capacity (e.g., 30 A) are connected in parallel to be applied to a register 96 connected at the rear end of the L2 terminal of the second relay 94.

The power having a third capacity (e.g., 60 A) and applied to the register 96 is decreased in voltage by register 96 to drive the cooling fan motor 70 having a fourth preset driving capacity (e.g., 380 W) at a low speed.

However, if it is determined at the above step S150 that the vehicle speed is above the first preset vehicle speed (e.g., 45 KPH), the ECU 60 determines whether the running speed is within a first preset range (S180). The first preset range is the first preset speed (e.g., 45 KPH)≦vehicle speed<second preset vehicle speed (e.g., 80KPH).

If it is determined in the above that the vehicle speed is within the first preset range, the ECU 60 determines whether the cooling water temperature of the vehicle in motion is above a third preset temperature (e.g., 94 degrees Celsius). (S190) If it is determined in the above that the cooling water temperature of the moving vehicle is above the third preset temperature (e.g., 94 degrees Celsius), the ECU 60 determines whether the cooling water temperature is above a fifth preset temperature (e.g., 100 degrees Celsius). (S200)

If it is determined in the above that the vehicle speed is within the first preset range and the cooling water temperature is above the fifth preset temperature (e.g., 100 degrees Celsius), the ECU 60 performs step S140 where a cooling fan is driven at a high speed.

However, if it is determined in the above that the vehicle speed is within the first preset range and the cooling water temperature is below the fifth preset temperature (e.g., 100 degree Celsius) but above the third preset temperature (e.g., 94 degrees Celsius), the ECU 60 performs step S170 where a cooling fan is driven at a low speed.

Furthermore, even if the vehicle speed is within the first preset range, if it is determined that the cooling water temperature of running vehicle is below the third preset temperature (by way of example, 94 degrees Celsius), the ECU 60 does not drive the cooling fan. (S210)

However, if it is determined that the vehicle speed is above the first preset range, the ECU 60 determines the changes of the cooling water temperature to see if the cooling water temperature is above the fifth preset temperature (e.g., 100 degrees Celsius). (S220)

If it is determined in the above that the vehicle in motion runs above the first preset range and the cooling water temperature is above the fifth preset temperature (e.g., 100 degrees Celsius), the ECU 60 performs step S140 where a cooling fan is driven at a high speed. However, even if the vehicle in motion runs above the first preset range and if the cooling water temperature is below the fifth preset temperature (e.g., 100 degrees Celsius), the ECU 60 does not drive the cooling fan.

However, in case an air conditioner switch is turned off in the above, or there is no air conditioner, the ECU 60 controls the drive of the cooling fan only with the vehicle speed and the cooling water temperature of the vehicle.

In other words, if it is determined that the running speed of the vehicle is below the second preset vehicle speed (e.g., 45 KPH) and the cooling water temperature is below the third preset temperature (e.g., 94 degrees Celsius) in a state where an air conditioner switch is either turned off or there is no air conditioner at all, the ECU 60 does not drive the cooling fan. (S300 and S310)

However, if it is determined in the above steps S300 and S310 that the vehicle moves at a speed less than the second preset speed (e.g., 45 KPH) and the cooling water temperature is above the fifth preset temperature (e.g., 100 degrees Celsius), the ECU 60 performs step S140 where a cooling fan is driven at a high speed. (S320)

However, if it is determined that the vehicle moves at a speed less than the second preset speed (e.g., 45 KPH) and the cooling water temperature is above the third preset temperature (e.g., 94 degrees Celsius) but less than the fifth preset temperature, the ECU 60 performs step S170 where a cooling fan is driven at a low speed.

If it is determined that the vehicle speed is above the second preset speed (e.g., 45 KPH), the ECU 60 determines whether the vehicle speed is within a first preset range (S330), where the first preset range (e.g., 45 KPH)≦vehicle speed<the fourth vehicle speed (e.g., 80 KPH).

As a result, if it is determined in the above step that the vehicle speed is within the first preset range, the ECU 60 determines whether the cooling water temperature of the vehicle in motion is above the third preset temperature (e.g., 94 degrees Celsius). (S340) If it is determined in the above that the cooling water temperature of the moving vehicle is above the third preset temperature (e.g., 94 degrees Celsius), the ECU 60 determines whether the cooling water temperature of the moving vehicle is above a sixth preset temperature (e.g., 105 degrees Celsius). (S 350)

If it is determined in the above that the moving speed of the vehicle is within the first preset range and the cooling water temperature is above the sixth preset temperature (e.g., 105 degrees Celsius), the ECU 60 performs step S140 where a cooling fan is driven at a high speed.

However, if it is determined in the above that the moving speed of the vehicle is within the first preset range and the cooling water temperature is above the third preset temperature (e.g., 94 degrees Celsius) but less than the sixth preset temperature (e.g., 105 degrees Celsius), the ECU 60 performs step S170 where a cooling fan is driven at a slow speed.

Successively, even if the moving speed of the vehicle is within the first preset range and if it is determined that the cooling water temperature is below the third preset temperature (e.g., 94 degrees Celsius), the ECU 60 does not drive the cooling fan.

Furthermore, if it is determined that the moving speed of the vehicle is above the first preset range, the ECU 60 checks the changes of the cooling water to determine whether the cooling water temperature is above a sixth preset temperature (e.g., 105 degrees Celsius). (S360)

If it is determined at the above step that the moving speed of the vehicle is above the first preset range and the cooling water temperature is above the sixth preset temperature (e.g., 105 degrees Celsius), the ECU 60 executes step S140 where a cooling fan is driven at a high speed.

However, even if the moving speed of the vehicle is above the first preset range and if the cooling water temperature is below the sixth preset temperature (e.g., 105 degrees Celsius), the ECU 60 does not drive the cooling fan.

As noted in the above, circuits in the conventional vehicular fuse box for controllably driving a double cooling fan are changed for parallel connection to controllably drive a single cooling fan having a preset high rated output such that the operating performance of the cooling fan can be improved and the number of parts are reduced to decrease the manufacturing cost.

As apparent from the foregoing, there is an advantage in the cooling fan control device thus described according to the present invention in that a double cooling fan control circuit conventionally used for cooling a radiator and a condenser of air conditioner is changed in construction thereof to a single cooling fan control circuit having a preset high rated output, thereby enabling to improve the operating performance of a cooling fan and to reduce the number of parts at a reduced manufacturing cost.

What is claimed is:

1. A cooling fan control device, the device comprising:
vehicle operation state detecting means for detecting cooling water temperature, vehicle speed, air conditioner switch state and refrigerant pressure that vary in response to vehicle operation state changes;
an electronic control unit for receiving data detected by said vehicle operation state detecting means to output a cooling fan control signal according to a preset program;
a first power supply unit for supplying a high fan speed driving power to a cooling fan motor according to the cooling fan control signal output from said electronic control unit; and
a second power supply unit for supplying a low fan speed driving power to the cooling fan motor according to the cooling fan control signal output from said electronic control unit.

2. The device as defined in claim 1, wherein said first power supply unit comprises a power source, a rated voltage fuse, and a relay for switchingly operating in response to the control of said electronic control unit to selectively provide power supplied via the fuse to the cooling fan motor.

3. The device as defined in claim 1, wherein said second power supply unit comprises a power source, a rated voltage fuse, a relay for switchingly operating in response to the control of said electronic control unit to selectively provide power supplied via the fuse to the cooling fan motor, and a register for dropping the voltage of power supplied via the relay to provide same to the cooling fan motor.

4. A cooling fan control device, comprising:
an electronic control unit configured to receive vehicle state information and to generate a cooling fan control signal based on said state information;
a first power supply unit communicating with said electronic control unit, said first power supply unit configured to supply high speed driving power to the cooling fan in accordance with said control signal; and
a second power supply unit communicating with said electronic control unit, said second power supply unit configured to supply low speed driving power to the cooling fan in accordance with said control signal.

5. The device of claim 4, wherein said vehicle state information comprises cooling water temperature, vehicle speed, air conditioner switch state and air conditioner refrigerant pressure.

6. The device of claim 4, wherein said electronic control unit generates said control signal in accordance with a control logic comprising comparing vehicle speed with at least one preset speed and cooling water temperature with at least one preset temperature.

7. The device of claim 6, wherein control logic further comprises:
determining whether an air conditioner switch is on or off;
executing a first set of speed and temperature comparisons if the switch is off; and
executing a second set of speed and temperature comparisons if the switch is on.
